(19) United States
(12) Patent Application Publication
(10) Pub. No.: US 2024/0152328 A1
(43) Pub. Date: May 9, 2024

(54) INDICATION OF QUALITY FOR RANDOM NUMBER GENERATION

(71) Applicant: Microchip Technology Incorporated, Chandler, AZ (US)

(72) Inventors: Alain Vergnes, Trets (FR); Sebastien Younes, Rousset (FR); Anthony Michel, Velaux (FR)

(21) Appl. No.: 18/053,458

(22) Filed: Nov. 8, 2022

(51) Int. Cl. G06F 7/58

(52) U.S. Cl. CPC G06F 7/58

(57) ABSTRACT

One or more examples relate to generation of quality indications for a randomly generated number or a random number generator more generally. An example apparatus may include a memory and a logic circuit. Such a memory is to receive and store a previous randomly generated number and a current randomly generated number. Such a logic circuit is to: determine a relationship between the previous randomly generated number and the current randomly generated number; and generate an indication of quality of the current randomly generated number at least partially responsive to the determined relationship between the previous randomly generated number and the current randomly generated number.

### TECHNICAL FIELD

One or more examples relate, generally, to random number generation and, more specifically, logic circuits to increase entropy of random number generation.

### BACKGROUND

Random number generators are electronic components found in many applications. For example, random number generators are specifically found in security components for applications that involve exchange of data, such as: automotive, industrial, internet-of-things, electronic metering, and point-of-sale.

### BRIEF DESCRIPTION OF THE DRAWINGS

To easily identify the discussion of any particular element or act, the most significant digit or digits in a reference number refer to the figure number in which that element is first introduced.

FIG. 1 is a block diagram depicting apparatus to generate an indication of quality of a randomly generated number, in accordance with one or more examples.

FIG. 2 is a functional block diagram depicting a system for conditioning the output of a random number generator, in accordance with one or more examples.

FIG. 3A is a functional block diagram depicting a random number generator in accordance with one or more examples.

FIG. 3B is a functional block diagram depicting an arrangement of a random number generator and an output conditioner, in accordance with one or more examples.

FIG. 4 is a functional block diagram depicting output conditioner to generate an indication that indicates whether or not a string distance between two numbers (i.e., randomly generated numbers) meets or exceeds a threshold.

FIG. 5 is a functional block diagram depicting output conditioner that gates provisioning of a randomly generated number responsive to indication whether or not a string distance between two numbers (i.e., randomly generated numbers) meets or exceeds a threshold.

FIG. 6 is a functional block diagram depicting an output conditioner to apply a correction to a randomly generated number to in response to detecting a threshold number of failed attempts to generate a randomly generated number.

FIG. 7 is a flow diagram depicting a process to generate an indication of quality of a randomly generated number, in accordance with one or more examples.

FIG. 8 is a flow diagram depicting a process to determine a relationship between a current randomly generated number and a previous randomly generated number, in accordance with one or more examples.

FIG. 9 is a flow diagram depicting a process to determine a string distance between a current randomly generated number and a previous randomly generated number, in accordance with one or more examples.

FIG. 10 is a flow diagram depicting an example of a process to apply a correction to a randomly generated number to in response to detecting a threshold number of failed attempts to generate a randomly generated number.

FIG. 11 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, logic, and circuits described in connection with the examples disclosed herein may be implemented or performed with a general purpose processor, a special purpose processor, a digital signal processor (DSP), an integrated circuit (IC), an Application Specific integrated circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may comprise one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

In this description, the term “coupled” and derivatives thereof may be used to indicate that two elements co-operate or interact with each other. When an element is described as being “coupled” to another element, then the elements may be in direct physical or electrical contact or there may be intervening elements or layers present. In contrast, when an element is described as being “directly coupled” to another element, then there are no intervening elements or layers present. The terms “on” and “connected” may be used in this description interchangeably with the term “coupled,” and have the same meaning unless expressly indicated otherwise or the context would indicate otherwise to a person having ordinary skill in the art.

Various applications for random number generators have differing requirements for randomness, the level of randomness referred to as “entropy.” As used herein, “quality” of a random number generator or a randomly generated number may be understood to be a representation of its entropy. It may be desirable for a random number generator or an electronic device that utilizes a random number generator, to include circuitry to generate indications of quality for randomly generated numbers, or a random number generator more generally.

Disclosed indications of quality may be utilized to condition an output of a random number generator such as: increase entropy of randomly generated numbers or random number generators, stored and made available to observers of a random number generator, provided with randomly generator numbers to indicate quality, or combinations thereof without limitation.

As a non-limiting example, disclosed indications of quality may be utilized to identify, for example, multiple instances of the same number, or insufficiently different numbers, generated by a random number generator or multiple random number generators in a system that sources randomly generated numbers from multiple random number generators. As a non-limiting example, disclosed indications of quality may be utilized to track and identify random number generators that do not exhibit sufficient entropy, for example, as represented by a predetermined threshold entropy. In various examples, values of threshold entropy may be user configurable, for example, set, and optionally reset, by a user.

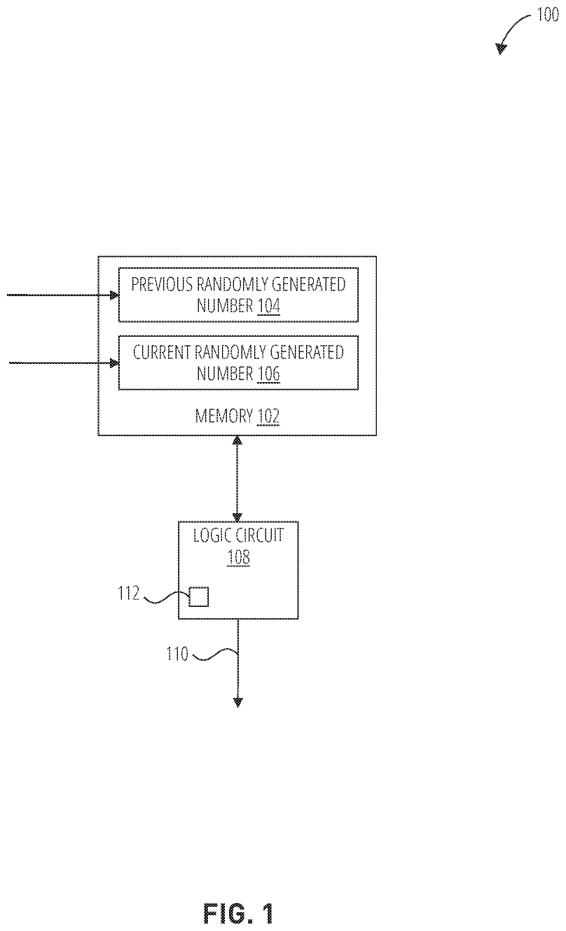

FIG. 1 is a block diagram depicting apparatus 100 to generate an indication of quality of a randomly generated number, in accordance with one or more examples. Apparatus 100 includes a memory 102 coupled with a logic circuit 108.

Memory 102 includes one or more non-transitory computer readable memories to receive and store previous randomly generated number 104 and current randomly generated number 106, respectively. In one or more examples, previous randomly generated numbers 104 and current randomly generated number 106 are strings of one or more digits (e.g., integer or floating point numbers, without limitation) generated responsive to random number generation processes. The respective random number generation processes responsive to which previous randomly generated number 104 and current randomly generated number 106 are generated may be the same or different. Further, the same random number generator or different random number generators may be utilized to generate previous randomly generated number 104 and current randomly generated number 106. In one or more examples, previous randomly generated number 104 was generated before (i.e., earlier in time) current randomly generated number 106.

In one or more examples, previous randomly generated number 104 and current randomly generated number 106 may have been generated in succession or with one or more intermediate randomly generated numbers generated there between. In one or more examples, previous randomly generated number 104 may be a most recent randomly generated number provided to a user (e.g., read by a user, without limitation).

Logic circuit 108 includes one or more combinational logic circuits to determine a relationship 112 (“determined relationship 112”) between previous randomly generated number 104 and current randomly generated number 106, and generate indication of quality 110 of current randomly generated number 106 at least partially responsive to determined relationship 112. In one or more examples, the determined relationship 112 may indicate a degree of sameness between respective previous randomly generated number 104 and current randomly generated number 106. In one or more examples, a degree of sameness may be utilized as an indication of magnitude of entropy of current randomly generated number 106.

One or more examples, relate, generally, to conditioning the output of a random number generator by generating and providing indication of quality 110 associated with current randomly generated number 106.

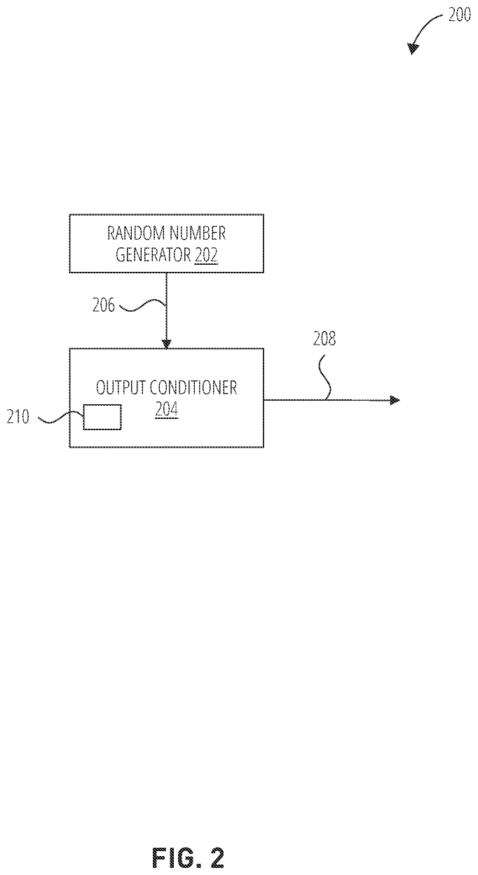

FIG. 2 is a functional block diagram depicting a system 200 for conditioning the output of a random number generator, in accordance with one or more examples. System 200 includes random number generator 202 and output conditioner 204.

Random number generator 202 generates a random number, such a random number provided as output 206 of random number generator 202 in system 200. Non-limiting examples of random number generators include a noise source coupled to an input of a string generator. Non-limiting examples of a noise source include an analog noise source such as a resistor and amplifier to generate a sufficient amplitude to drive an analog-to-digital-converter, a digital noise source such as one or more variable or fixed frequency ring oscillators, or a combination thereof.

Output conditioner 204 conditions output 206 of random number generator 202 at least partially responsive to an indication of quality 210 of a number generated by random number generator 202, such conditioning represented by conditioned output 208 in FIG. 2. As described herein, conditioning the output of a random number generator may include, but is not limited to, providing a value together with a randomly generated number, where the value represents a quality of the randomly generated number, or filtering the output of a random number generator to pass only randomly generated numbers having an associated indication of quality that meets or exceeds a quality threshold. In one or more examples, output conditioner 204 may include a logic circuit 108 or apparatus 100 of FIG. 1, to generate indication of quality 210.

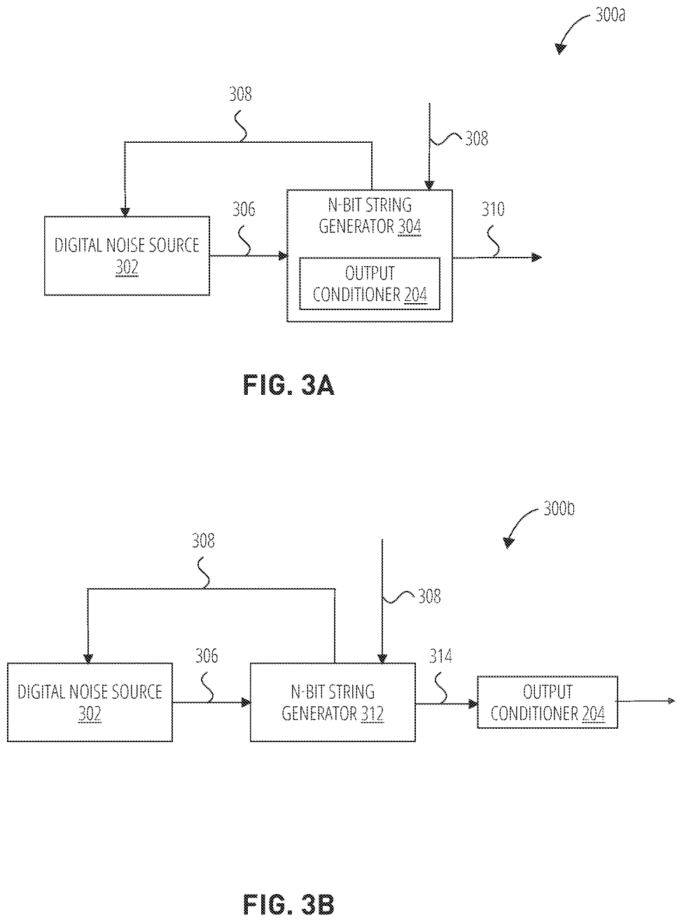

In one or more examples, a disclosed output conditioner may be coupled to an output of a random number generator—e.g., as in examples depicted by FIG. 1 and FIG. 3B. Additionally or alternatively, a disclosed output conditioner may be within a random number generator, and more specifically, a string generator of the random number generator as in the example depicted by FIG. 3A.

FIG. 3A is a functional block diagram of a random number generator 300a that includes a string generator (here, N-bit string generator 304) that includes an output conditioner 204, in accordance with one or more examples.

Random number generator 300a may include digital noise source 302 and N-bit string generator 304. Digital noise source 302 generates digital noise signal 306 at least partially responsive to control signal 308. In one or more examples, digital noise source 302 is an entropy source for random number generation. Any suitable digital entropy source may be utilized for digital noise source 302, including, but not limited to, digital entropy generators (e.g., a variable or fixed frequency ring oscillator, without limitation) or a digital entropy generator that utilizes computational entropy.

A non-limiting example of a digital noise source that utilizes computational entropy is a pair of coupled or cross-coupled linear-feedback shift registers (LFSR) clocked by a variable or fixed frequency ring oscillator. In the case of a pair of cross-coupled LFSRs, the shifted values in respective LFSRs are utilized to modify a bus clock that clocks the variable frequency ring oscillator of the other one of the pair that does not clock the respective LFSR.

In one or more examples, an output 306 of digital noise source 302 may be a one or multi-bit signal (e.g., generated by one or more variable or fixed frequency ring oscillators, without limitation). N-bit string generator 304 generates an N-bit string responsive to the stream of one or multi-bit signal output 306, where the randomly generated number 310 is the generated N-bit string.

Optionally, N-bit string generator 304 may generate control signal 308 at least partially responsive to modified clock signal 316 and a previous digital noise signal of digital noise signal 306 generated by digital noise source 302. The optional feedback loop may serve to increase entropy in the output of digital noise source 302.

N-bit string generator 304 includes output conditioner 204 to condition the output 310 of N-bit string generator 304. In various examples, output conditioner 204 may condition the output 310 by providing an indication of quality (e.g., an indication of quality 110, without limitation) with output 310, or providing indications of quality for intermediate randomly generated numbers determined by N-bit string generator 304, and N-bit string generator 304 may select or discard intermediate randomly generated numbers at least partially based on indications of quality provided by output conditioner 204, as discussed below, to generate output 310.

FIG. 3B is a block diagram depicting the arrangement where an input of output conditioner 204 is coupled to receive an output 314 of N-bit string generator 312, which may be optionally part of a logic circuit of random number generator 300b or optionally apart from the logic circuit of random number generator 300b, in a separate logic circuit.

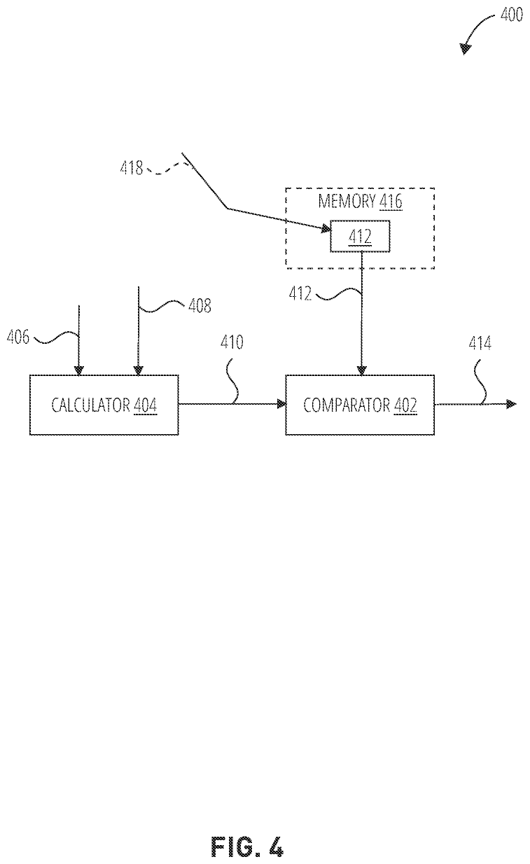

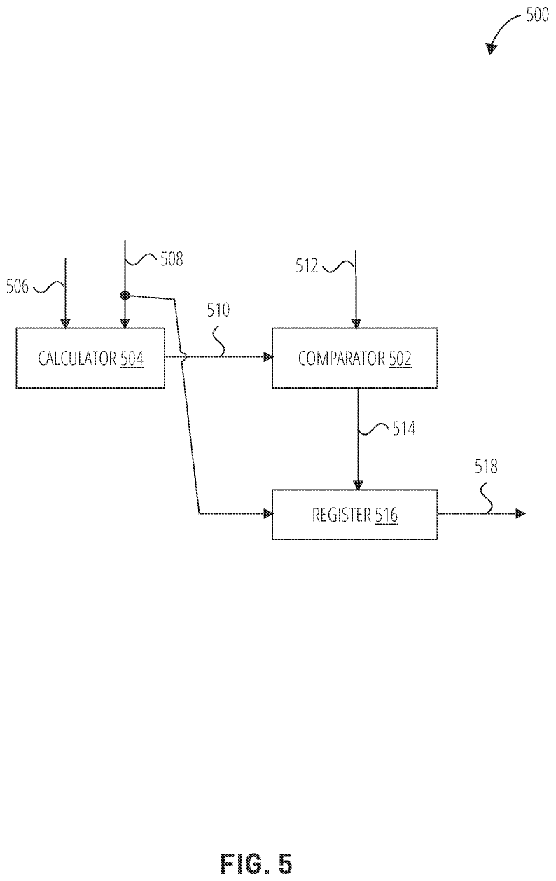

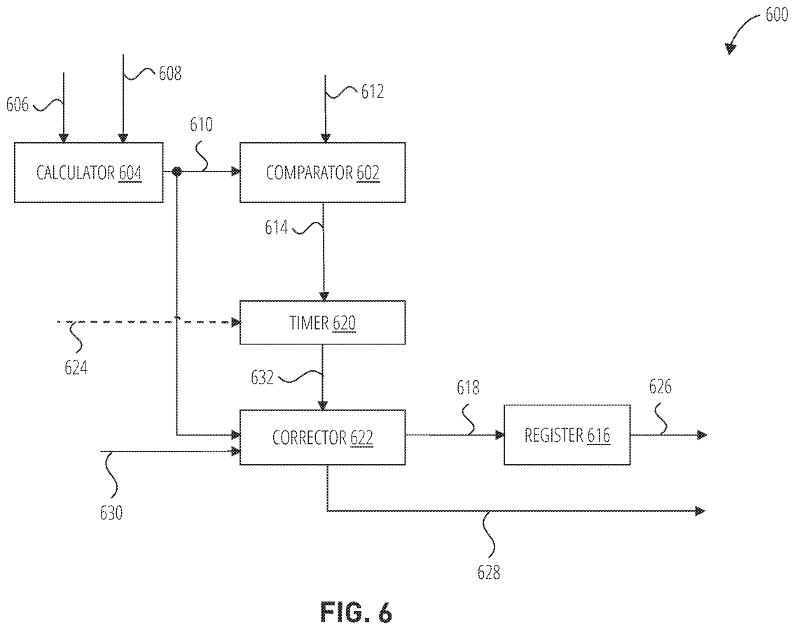

FIG. 4, FIG. 5, and FIG. 6 depict examples of output conditioners, including output conditioner 204 of FIG. 2.

FIG. 4 is a functional block diagram depicting output conditioner 400 to generate an indication 414 that indicates whether or not a string distance between two numbers (i.e., randomly generated numbers) meets or exceeds a threshold.

Output conditioner 400 includes calculator 404 and a comparator 402. Calculator 404 is to calculate a string distance 410 between previous randomly generated number 406 and current randomly generated number 408. Comparator 402 is to generate indication 414, which is an indication of a relationship between string distance threshold 412 and string distance 410. Indication 414 is a further indication of the state of current randomly generated number 408. In this case, a value of string distance 410 equal to or greater than a value of string distance threshold 412 may correspond to a first state of current randomly generated number 408, and a value of string distance 410 less than a value of string distance threshold 412 may correspond to a second, different, state of current randomly generated number 408.

In one or more examples, a value of string distance threshold 412 may be a set value 418, which is provided by a user and stored at an optional memory 416 (which memory 416 may be the same or different memory than memory 102 of FIG. 1). In one or more examples, a value of string distance threshold 412 may be programmable or hardcoded at output conditioner 400.

FIG. 5 is a functional block diagram depicting output conditioner 500 that gates provisioning of a randomly generated number responsive to indication 514 whether or not a string distance between two numbers (i.e., randomly generated numbers) meets or exceeds a threshold, in accordance with one or more examples. Output conditioner 500 is a non-limiting example of output conditioner 204 of FIG. 2.

Output conditioner 500 includes calculator 504, comparator 502, and register 516. Calculator 504 is to calculate a string distance 510 between current randomly generated number 508 and previous randomly generated number 506. Comparator 502 is to generate indication 514 of a state of current randomly generated number 508 at least partially responsive to string distance 510 and string distance threshold 512.

Register 516 is to sample and hold current randomly generated number 508 at least partially responsive to indication 514 of the state of current randomly generated number 508.

As non-limiting example, a value of string distance threshold 512 may represent a predetermined minimum acceptable string distance between current randomly generated number 508 and previous randomly generated number 506. In such a case, register 516 may sample and hold current randomly generated number 508 when a value of string distance 510 meets or exceeds a value of string distance threshold 512. When indication 514 indicates a value indication of quality 110 meets or exceeds a value of string distance threshold 512, indication 518 may be asserted to indicate a valid random number is stored at register 516 and available to be read by a user. When indication 514 indicates a value indication of quality 110 does not meet or exceed a value of string distance threshold 512 indication 518 may be de-asserted to indicate that no valid number is stored at register 516 nor available to be read by a user.

FIG. 6 is a functional block diagram depicting an output conditioner 600 to apply a transformation (e.g., a correction) to a randomly generated number to in response to detecting a threshold number of failed attempts to generate a randomly generated number, in accordance with one or more examples. Output conditioner 600 is a non-limiting example of output conditioner 204 of FIG. 2.

Output conditioner 600 includes a comparator 602, a calculator 604, a timer 620, corrector 622, and register 616.

Calculator 604 is to calculate a string distance 610 between current randomly generated number 608 and previous randomly generated number 606. Comparator 602 is to generate an indication 614 of a state of current randomly generated number 608 at least partially responsive to a comparison of string distance 610 and string distance threshold 612.

Timer 620 is to generate a value time 632 that represents a time duration (e.g., a counted clock cycles of optional clock signal 624 or a counted number of generated random numbers, without limitation) since a last indication 614 generated by comparator 602 indicating that a value of calculated string distance 610 exceeded a value of string distance threshold 612.

Corrector 622 is to generate an output 618 that comprises: a transformed current randomly generated number at least partially responsive to detecting that time 632 generated by timer 620 exceeded a value of a time-out threshold 630; or current randomly generated number 608 at least partially responsive to detecting that the value of time 632 generated by timer 620 reset before exceeding a value of time-out threshold 630. Corrector 622 may also generate an indication 628, which is an indication of quality for randomly generated number 626.

Non-limiting examples of an algorithm for transforming the randomly generated number includes a bitwise exclusive OR (XOR) operation on each and every bit of a previously randomly generated number that met the quality requirements. For each and every bit, one input of the XOR is driven by a bit of the previously randomly generated number and the other input of the XOR is driven by the output of the timer 620. In the case of a timeout event, a new randomly generated value is a “negation” of the previously randomly generated number, thus, a max hamming distance between the number generated by the XOR operation and the previously generated random number. In various examples, the XOR operation can be applied to fewer than each and every bit of the previously randomly generated number as long as it is applied to enough bits to be equal to or greater than a value of string distance threshold 612. In one or more examples, the number of bits to which the XOR operation can be applied may be variable as long as applied to enough bits to be equal to or greater than a value of string distance threshold 612.

Register 616 is to store the output 618 of corrector 622, and provide randomly generated number 626, which is either current randomly generated number 608 or a transformed version of current randomly generated number 608.

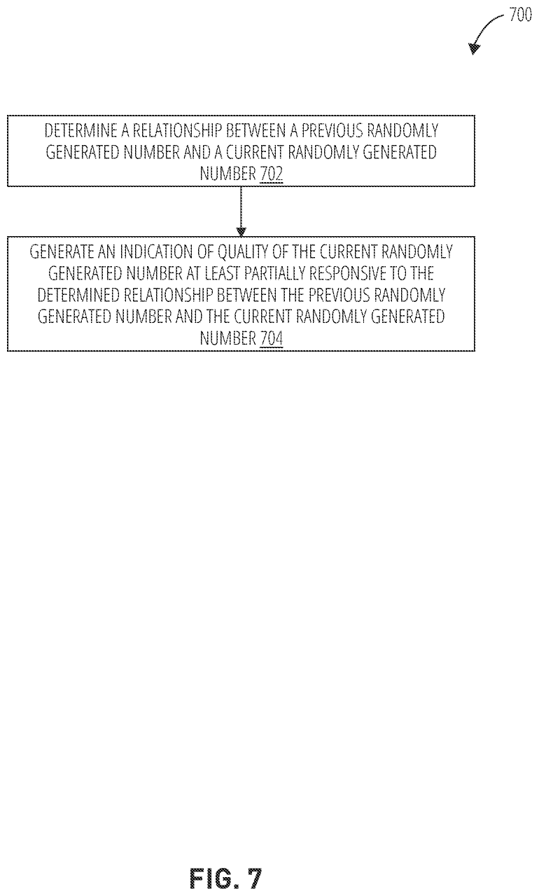

FIG. 7 is a flow diagram depicting a process 700 to generate an indication of quality of a randomly generated number, in accordance with one or more examples. Process 700 may be performed, as a non-limiting example, by logic circuit 108 in cooperation with values for previous randomly generated number 104 and current randomly generated number 106 stored at memory 102, to generate an indication of quality.

In operation 702, process 700 determines a relationship between a previous randomly generated number and a current randomly generated number. As discussed above, the determined relationship is an indication of entropy of the current randomly generated number.

In operation 704, process 700 generates an indication of quality of the current randomly generated number at least partially responsive to the determined relationship between the previous randomly generated number and the current randomly generated number.

In one or more examples, string distance is utilized as an indication of entropy of a randomly generated number, and more specifically, string distance between a currently generated random number and previously generated random number. String distance is a value that represents a degree of similar between two strings of symbols. In one or more examples, similarity may be determined at a bit level, symbol level, or combinations thereof. Any suitable algorithm may be utilized to determine string distance in various examples.

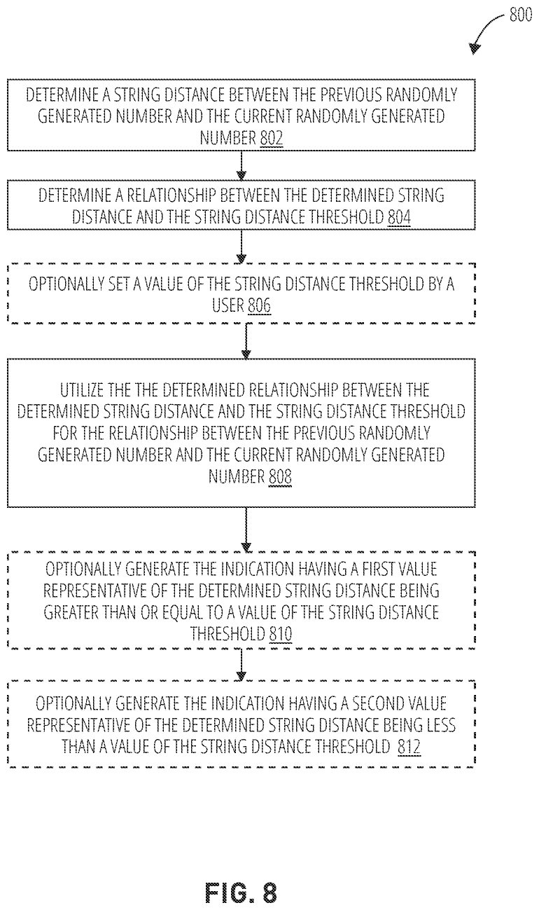

FIG. 8 is a flow diagram depicting a process 800 to determine a relationship between a current randomly generated number and a previous randomly generated number, in accordance with one or more examples.

In operation 802, process 800 determines a string distance between a previous randomly generated number and a current randomly generated number. More specifically, process 800 may generate a value that represents the string distance between a previous randomly generated number and a current randomly generated number. The value may be a digital value.

In operation 804, process 800 determines a relationship between the determined string distance and a string distance threshold. String distance threshold represents a target or desired minimum degree of similarity between the current randomly generated number and the previous randomly generated number. In various examples, a value that represents the string distance threshold may be predetermined value, set by a user, for example, a user of apparatus 100 without limitation.

In optional operation 806, process 800 optionally set a value of the string distance threshold by a user.

In operation 808, process 800 utilizes the determined relationship between the determined string distance and the string distance threshold for the relationship between the previous randomly generated number and the current randomly generated number determined by the relationship determination logic comprises.

In optional operation 810, process 800 generates the indication having a first value representative of the determined string distance being greater than or equal to a value of the string distance threshold.

In optional operation 812, process 800 generates the indication having a second value representative of the determined string distance being less than a value of the string distance threshold.

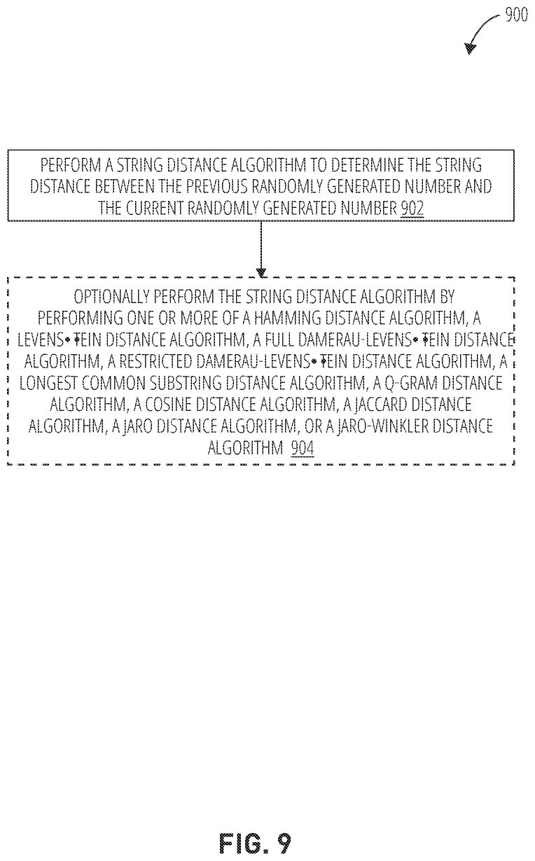

FIG. 9 is a flow diagram depicting a process 900 to determine a string distance between a current randomly generated number and a previous randomly generated number, in accordance with one or more examples.

In operation 902, process 900 performs a string distance algorithm to determine the string distance between the previous randomly generated number and the current randomly generated number.

In optional operation 904, process 900 optionally performs the string distance algorithm by performing one or more of a hamming distance algorithm, a levenshtein distance algorithm, a full damerau-levenshtein distance algorithm, a restricted damerau-levenshtein distance algorithm, a longest common substring distance algorithm, a q-gram distance algorithm, a cosine distance algorithm, a jaccard distance algorithm, a jaro distance algorithm, or a jaro-winkler distance algorithm.

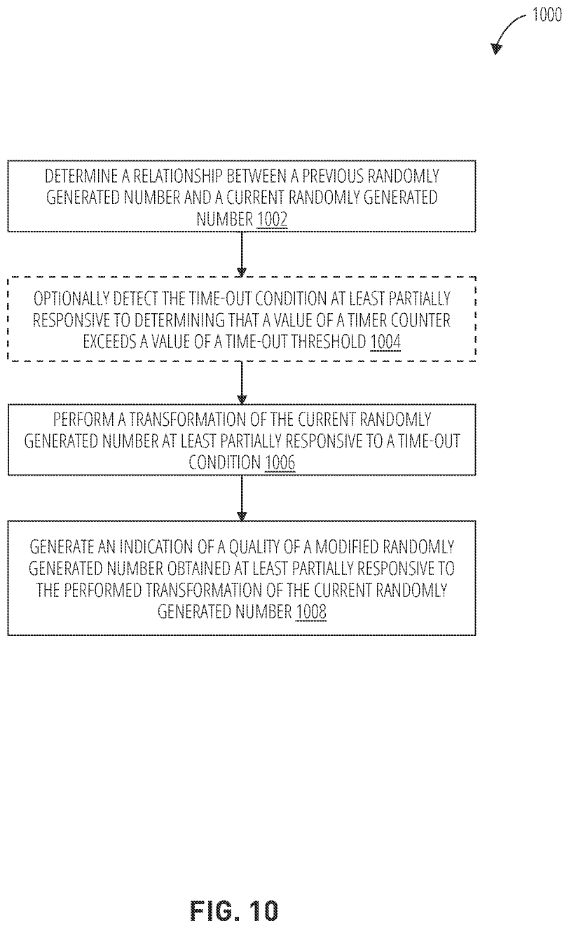

FIG. 10 is a flow diagram depicting an example of a process 1000 to apply a correction to a randomly generated number to in response to detecting a threshold number of failed attempts to generate a randomly generated number.

In operation 1002, process 1000 determines a relationship between a previous randomly generated number and a current randomly generated number.

In optional operation 1004, process 1000 detects the time-out condition at least partially responsive to determining that a value of a timer counter exceeds a value of a time-out threshold. In one or more examples, process 1000 determines if the number of consecutive randomly generated numbers meets or exceeds a hardcoded or configurable threshold and if it does, detects the time-out condition.

In operation 1006, process 1000 performs a transformation of the current randomly generated number at least partially responsive to a time-out condition. In one or more examples, process 1000 applies a bitwise XOR with a previously randomly generated number. A first input of the XOR circuit is driven by the timer and a second input of the XOR circuit is driven by the bits of the previous randomly generated number.

In operation 1008, process 1000 generates an indication of a quality of a modified randomly generated number obtained at least partially responsive to the performed transformation of the current randomly generated number.

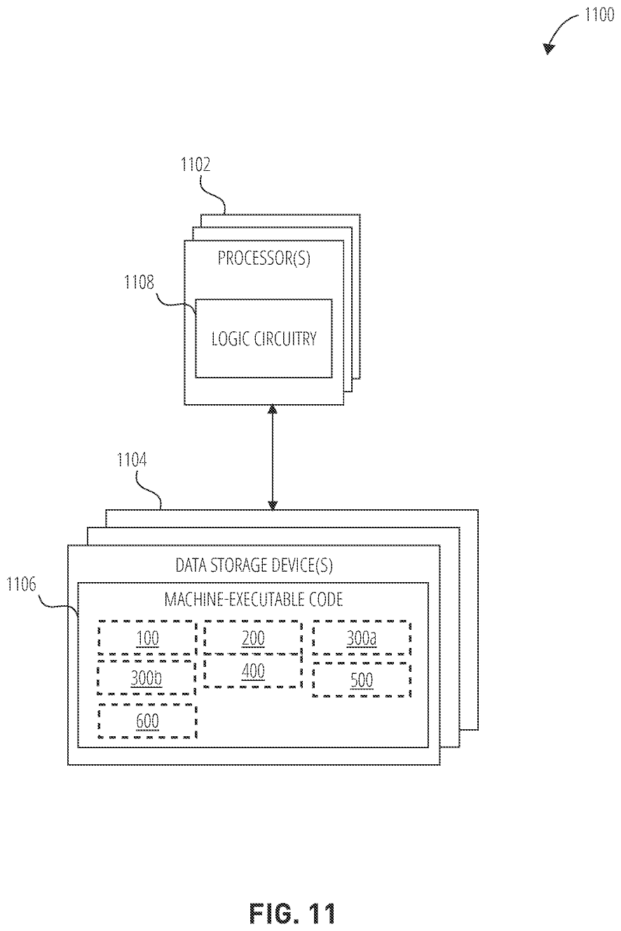

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 11 illustrates non-limiting examples of implementations of functional elements disclosed herein. In some examples, some or all portions of the functional elements disclosed herein may be performed by hardware specially configured for carrying out the functional elements.

FIG. 11 is a block diagram of circuitry 1100 that, in some examples, may be used to implement various functions, operations, acts, processes, and/or methods disclosed herein. The circuitry 1100 includes one or more processors 1102 (sometimes referred to herein as “processors 1102”) operably coupled to one or more data storage devices (sometimes referred to herein as “storage 804”). The storage 1104 includes machine-executable code 1106 stored thereon and the processors 1102 include logic circuitry 1108. The machine-executable code 1106 includes information describing functional elements that may be implemented by (e.g., performed by) the logic circuitry 1108. The logic circuitry 1108 is adapted to implement (e.g., perform) the functional elements described by the machine-executable code 1106. The circuitry 1100, when executing the functional elements described by the machine-executable code 1106, should be considered as special purpose hardware configured for carrying out functional elements disclosed herein. In some examples the processors 1102 may be configured to perform the functional elements described by the machine-executable code 1106 sequentially, concurrently (e.g., on one or more different hardware platforms), or in one or more parallel process streams.

When implemented by logic circuitry 1108 of the processors 1102, the machine-executable code 1106 is configured to adapt the processors 1102 to perform operations of examples disclosed herein, including for output conditioning or generating indications of quality as described herein. By way of non-limiting example, the machine-executable code 1106 may be configured to adapt the processors 1102 to perform some or a totality of operations of one or more of: process 700, process 800, process 900, or process 1000.

Also by way of non-limiting example, the machine-executable code 1106 may be configured to adapt the processors 1102 to perform some or a totality of features, functions, or operations disclosed herein for one or more of: logic circuit 108, memory 102; random number generator 202 or output conditioner 204; digital noise source 302, N-bit string generator 304; calculator 404, comparator 402, or memory 416; calculator 504, comparator 502, register 516; calculator 604, comparator 602, timer 620, corrector 622 or register 616.

The processors 1102 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute functional elements corresponding to the machine-executable code 1106 (e.g., software code, firmware code, hardware descriptions) related to examples of the present disclosure. It is noted that a general-purpose processor (may also be referred to herein as a host processor or simply a host) may be a microprocessor, but in the alternative, the processors 1102 may include any conventional processor, controller, microcontroller, or state machine. The processors 1102 may also be implemented as a combination of computing devices, such as a combination of a DSP and a microprocessor, a plurality of microprocessors, one or more microprocessors in conjunction with a DSP core, or any other such configuration.

In some examples the storage 1104 includes volatile data storage (e.g., random-access memory (RAM)), non-volatile data storage (e.g., Flash memory, a hard disc drive, a solid state drive, erasable programmable read-only memory (EPROM), etc.). In some examples the processors 1102 and the storage 1104 may be implemented into a single device (e.g., a semiconductor device product, a system on chip (SOC), etc.). In some examples the processors 1102 and the storage 1104 may be implemented into separate devices.

In some examples the machine-executable code 1106 may include computer-readable instructions (e.g., software code, firmware code). By way of non-limiting example, the computer-readable instructions may be stored by the storage 1104, accessed directly by the processors 1102, and executed by the processors 1102 using at least the logic circuitry 1108. Also by way of non-limiting example, the computer-readable instructions may be stored on the storage 1104, transferred to a memory device (not shown) for execution, and executed by the processors 1102 using at least the logic circuitry 1108. Accordingly, in some examples the logic circuitry 1108 includes electrically configurable logic circuitry 1108.

In some examples the machine-executable code 1106 may describe hardware (e.g., circuitry) to be implemented in the logic circuitry 1108 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, SystemVerilog or very large scale integration (VLSI) hardware description language (VHDL) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuitry 1108 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1106 may include an HDL, an RTL, a GL description, a mask level description, other hardware description, or any combination thereof.

In examples where the machine-executable code 1106 includes a hardware description (at any level of abstraction), a system (not shown, but including the storage 1104) may be configured to implement the hardware description described by the machine-executable code 1106. By way of non-limiting example, the processors 1102 may include a programmable logic device (e.g., an FPGA or a PLC) and the logic circuitry 1108 may be electrically controlled to implement circuitry corresponding to the hardware description into the logic circuitry 1108. Also by way of non-limiting example, the logic circuitry 1108 may include hard-wired logic manufactured by a manufacturing system (not shown, but including the storage 1104) according to the hardware description of the machine-executable code 1106.

Regardless of whether the machine-executable code 1106 includes computer-readable instructions or a hardware description, the logic circuitry 1108 is adapted to perform the functional elements described by the machine-executable code 1106 when implementing the functional elements of the machine-executable code 1106. It is noted that although a hardware description may not directly describe functional elements, a hardware description indirectly describes functional elements that the hardware elements described by the hardware description are capable of performing.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims, without limitation) are generally intended as “open” terms (e.g., the term “including” should be interpreted as “including, but not limited to,” the term “having” should be interpreted as “having at least,” the term “includes” should be interpreted as “includes, but is not limited to,” without limitation). As used herein, the term “each” means some or a totality. As used herein, the term “each and every” means a totality.

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more,” without limitation); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations, without limitation). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.” As used herein, “each” means some or a totality, and “each and every” means a totality.

While the present disclosure has been described herein with respect to certain illustrated embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

Non-limiting example embodiments of the present disclosure may include:

Example 1: An apparatus, comprising: a memory to receive and store a previous randomly generated number and a current randomly generated number; and a logic circuit to:determine a relationship between the previous randomly generated number and the current randomly generated number; and generate an indication of quality of the current randomly generated number at least partially responsive to the determined relationship between the previous randomly generated number and the current randomly generated number.

Example 2: The apparatus according to Example 1, wherein the logic circuit to:determine a string distance between the previous randomly generated number and the current randomly generated number; determine a relationship between the determined string distance and a string distance threshold; and utilize the determined relationship between the determined string distance and the string distance threshold for the relationship between the previous randomly generated number and the current randomly generated number.

Example 3: The apparatus according to any of Examples 1 and 2, wherein the logic circuit to: generate the indication of quality having a first value indicative of a first relationship between the determined string distance and the string distance threshold; and generate the indication of quality having a second value indicative of a second relationship between the determined string distance and the string distance threshold.

Example 4: The apparatus according to any of Examples 1 through 3, wherein the first relationship is that a value of the determined string distance is less than a value of the string distance threshold.

Example 5: The apparatus according to any of Examples 1 through 4, wherein the second relationship is that a value of the determined string distance is greater than or equal to a value of the string distance threshold.

Example 6: The apparatus according to any of Examples 1 through 5, wherein a value of the string distance threshold is user configurable.

Example 7: The apparatus according to any of Examples 1 through 6, wherein the logic circuit to: performs a string distance algorithm to determine the string distance between the previous randomly generated number and the current randomly generated number.

Example 8: The apparatus according to any of Examples 1 through 7, wherein the string distance algorithm comprises one or more of: a Hamming distance algorithm, a Levenshtein distance algorithm, a full Damerau-Levenshtein distance algorithm, a restricted Damerau-Levenshtein distance algorithm, a longest common substring distance algorithm, a q-gram distance algorithm, a cosine distance algorithm, a Jaccard distance algorithm, a Jaro distance algorithm, or a Jaro-Winkler distance algorithm.

Example 9: The apparatus according to any of Examples 1 through 8, comprising: a further memory to store a time-out threshold, wherein the logic circuit to:detect a time-out condition at least partially responsive to a relationship between a timer count and the time-out threshold; and transform the current randomly generated number at least partially responsive to detection of the time-out condition.

Example 10: The apparatus according to any of Examples 1 through 9, wherein the logic circuit to detect the time-out condition at least partially responsive to a determination that a value of the timer count exceeds a value of the time-out threshold.

Example 11: The apparatus according to any of Examples 1 through 10, wherein the logic circuit to generate an indication of a quality of a modified current randomly generated number obtained at least partially responsive to the performed transformation of the current randomly generated number.

Example 12: A method, comprising: determining a relationship between a previous randomly generated number and a current randomly generated number; and generating an indication of a quality of the current randomly generated number at least partially responsive to the determined relationship between the previous randomly generated number and the current randomly generated number.

Example 13: The method according to Example 12, comprising: receiving a string distance threshold; determining a string distance between the previous randomly generated number and the current randomly generated number; determining a relationship between the determined string distance and the string distance threshold; and determining the relationship between the previous randomly generated number and the current randomly generated number at least partially responsive to the determined relationship between the determined string distance and the string distance threshold.

Example 14: The method according to any of Examples 12 and 13, comprising: generating the indication having a first value representing the determined string distance being greater than or equal to a value of the string distance threshold; and generating the indication having a second value representing the determined string distance being less than a value of the string distance threshold.

Example 15: The method according to any of Examples 12 through 14, wherein a value of the string distance threshold is user configurable.

Example 16: The method according to any of Examples 12 through 15, comprising: performing a string distance algorithm to determine the string distance between the previous randomly generated number and the current randomly generated number.

Example 17: The method according to any of Examples 12 through 16, wherein performing the string distance algorithm comprises performing one or more of a Hamming distance algorithm, a Levenshtein distance algorithm, a FFfull Damerau-Levenshtein distance algorithm, a restricted Damerau-Levenshtein distance algorithm, a longest common substring distance algorithm, a q-gram distance algorithm, a cosine distance algorithm, a Jaccard distance algorithm, a Jaro distance algorithm, or a Jaro-Winkler distance algorithm.

Example 18: The method according to any of Examples 12 through 17, comprising: performing a transformation of the current randomly generated number at least partially responsive to a time-out condition.

Example 19: The method according to any of Examples 12 through 18, comprising: detecting the time-out condition at least partially responsive to determining that a value of a timer counter exceeds a value of a time-out threshold.

Example 20: The method according to any of Examples 12 through 19, wherein the generating the indication of the quality of the current randomly generated number comprises: generating an indication of a quality of a modified current randomly generated number obtained at least partially responsive to the performed transformation of the current randomly generated number.

Example 21: A system comprising: a random number generator; and an output conditioner to condition an output of the random number generator at least partially responsive to an indication of quality of a number generated by the random number generator.

Example 22: The system according to Example 21, wherein the random number generator comprises: a digital noise source to generate a digital noise signal at least partially responsive to a control signal; and an n-bit string generator to generate the control signal at least partially responsive to a modified clock signal and a previous digital noise signal generated by the digital noise source.

Example 23: The system according to any of Examples 21 and 22, wherein the n-bit string generator includes the output conditioner.

Example 24: The system according to any of Examples 21 through 23, wherein the output conditioner is coupled to an output of the n-bit string generator of the random number generator.

Example 25: The system according to any of Examples 21 through 24, wherein the output conditioner comprises: a calculator to calculate a string distance at least partially responsive to a current randomly generated number and a previous randomly generated number; and a comparator to generate a conditioned output comprising an indication of a state of the current randomly generated number at least partially responsive to a comparison of the calculated string distance and a string distance threshold.

Example 26: The system according to any of Examples 21 through 25, wherein the output conditioner comprises: a calculator to calculate a string distance at least partially responsive to a current randomly generated number and a previous randomly generated number; a comparator to generate an indication of a state of the current randomly generated number at least partially responsive to a comparison of the calculated string distance and a string distance threshold; and a register responsive to the indication of the state of the current randomly generated number, sample and hold the current randomly generated number.

Example 27: The system according to any of Examples 21 through 26, wherein the output conditioner comprises: a calculator to calculate a string distance at least partially responsive to a current randomly generated number and a previous randomly generated number; a comparator to generate an indication of a state of the current randomly generated number at least partially responsive to a comparison of the calculated string distance and a string distance threshold; a timer to generate a value indicative of a time duration since a last indication generated by the comparator that corresponds to the calculated string distance exceeding the string distance threshold; a corrector to output: a transformed current randomly generated number at least partially responsive to detecting that the value generated by the timer exceeded a value of a time-out threshold; or the current randomly generated number at least partially responsive to detecting that the value generated by a timer reset before exceeding the time-out threshold, and a register to store the output of the corrector.

Example 28: The system according to any of Examples 21 through 27, wherein the corrector to generate an indication of the quality of the output stored at the register.

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those skilled in the art from the description. Such modifications and embodiments also fall within the scope of the appended claims and equivalents.

What is claimed is:

1. An apparatus, comprising:
a memory to receive and store a previous randomly generated number and a current randomly generated number; and
a logic circuit to:
determine a relationship between the previous randomly generated number and the current randomly generated number; and
generate an indication of quality of the current randomly generated number at least partially responsive to the determined relationship between the previous randomly generated number and the current randomly generated number.

2. The apparatus of claim 1, wherein the logic circuit to:
determine a string distance between the previous randomly generated number and the current randomly generated number;
determine a relationship between the determined string distance and a string distance threshold; and
utilize the determined relationship between the determined string distance and the string distance threshold for the relationship between the previous randomly generated number and the current randomly generated number.

3. The apparatus of claim 2, wherein the logic circuit to:
generate the indication of quality having a first value indicative of a first relationship between the determined string distance and the string distance threshold; and
generate the indication of quality having a second value indicative of a second relationship between the determined string distance and the string distance threshold.

4. The apparatus of claim 3, wherein the first relationship is that a value of the determined string distance is less than a value of the string distance threshold.

5. The apparatus of claim 3, wherein the second relationship is that a value of the determined string distance is greater than or equal to a value of the string distance threshold.

6. The apparatus of claim 2, wherein a value of the string distance threshold is user configurable.

7. The apparatus of claim 2, wherein the logic circuit to:
perform a string distance algorithm to determine the string distance between the previous randomly generated number and the current randomly generated number.

8. The apparatus of claim 7, wherein the string distance algorithm comprises one or more of: a Hamming distance algorithm, a Levenshtein distance algorithm, a full Damerau-Levenshtein distance algorithm, a restricted Damerau-Levenshtein distance algorithm, a longest common substring distance algorithm, a q-gram distance algorithm, a cosine distance algorithm, a Jaccard distance algorithm, a Jaro distance algorithm, or a Jaro-Winkler distance algorithm.

9. The apparatus of claim 1, comprising:
a further memory to store a time-out threshold,
wherein the logic circuit to:
detect a time-out condition at least partially responsive to a relationship between a timer count and the time-out threshold; and
transform the current randomly generated number at least partially responsive to detection of the time-out condition.

10. The apparatus of claim 9, wherein the logic circuit to detect the time-out condition at least partially responsive to a determination that a value of the timer count exceeds a value of the time-out threshold.

11. The apparatus of claim 9, wherein the logic circuit to generate an indication of a quality of a modified current randomly generated number obtained at least partially responsive to the performed transformation of the current randomly generated number.

12. A method, comprising:
determining a relationship between a previous randomly generated number and a current randomly generated number; and
generating an indication of a quality of the current randomly generated number at least partially responsive to the determined relationship between the previous randomly generated number and the current randomly generated number.

13. The method of claim 12, comprising:
receiving a string distance threshold;
determining a string distance between the previous randomly generated number and the current randomly generated number;
determining a relationship between the determined string distance and the string distance threshold; and
determining the relationship between the previous randomly generated number and the current randomly generated number at least partially responsive to the determined relationship between the determined string distance and the string distance threshold.

14. The method of claim 13, comprising:
generating the indication having a first value representing the determined string distance being greater than or equal to a value of the string distance threshold; and
generating the indication having a second value representing the determined string distance being less than a value of the string distance threshold.

15. The method of claim 13, wherein a value of the string distance threshold is user configurable.

16. The method of claim 13, comprising:
performing a string distance algorithm to determine the string distance between the previous randomly generated number and the current randomly generated number.

17. The method of claim 16, wherein performing the string distance algorithm comprises performing one or more of: a Hamming distance algorithm, a Levenshtein distance algorithm, a FFfull Damerau-Levenshtein distance algorithm, a restricted Damerau-Levenshtein distance algorithm, a longest common substring distance algorithm, a q-gram distance algorithm, a cosine distance algorithm, a Jaccard distance algorithm, a Jaro distance algorithm, or a Jaro-Winkler distance algorithm.

18. The method of claim 12, comprising:
performing a transformation of the current randomly generated number at least partially responsive to a time-out condition.

19. The method of claim 18, comprising:
detecting the time-out condition at least partially responsive to determining that a value of a timer counter exceeds a value of a time-out threshold.

20. The method of claim 18, wherein the generating the indication of the quality of the current randomly generated number comprises:
generating an indication of a quality of a modified current randomly generated number obtained at least partially responsive to the performed transformation of the current randomly generated number.

21. A system comprising:
a random number generator; and
an output conditioner to condition an output of the random number generator at least partially responsive to an indication of quality of a number generated by the random number generator.

22. The system of claim 21, wherein the random number generator comprises:
a digital noise source to generate a digital noise signal at least partially responsive to a control signal; and
an n-bit string generator to generate the control signal at least partially responsive to a modified clock signal and a previous digital noise signal generated by the digital noise source.

23. The system of claim 22, wherein the n-bit string generator includes the output conditioner.

24. The system of claim 22, wherein the output conditioner is coupled to an output of the n-bit string generator of the random number generator.

25. The system of claim 21, wherein the output conditioner comprises:
a calculator to calculate a string distance at least partially responsive to a current randomly generated number and a previous randomly generated number; and
a comparator to generate a conditioned output comprising an indication of a state of the current randomly generated number at least partially responsive to a comparison of the calculated string distance and a string distance threshold.

26. The system of claim 21, wherein the output conditioner comprises:
a calculator to calculate a string distance at least partially responsive to a current randomly generated number and a previous randomly generated number;
a comparator to generate an indication of a state of the current randomly generated number at least partially responsive to a comparison of the calculated string distance and a string distance threshold; and
a register responsive to the indication of the state of the current randomly generated number, sample and hold the current randomly generated number.

27. The system of claim 21, wherein the output conditioner comprises:
a calculator to calculate a string distance at least partially responsive to a current randomly generated number and a previous randomly generated number;
a comparator to generate an indication of a state of the current randomly generated number at least partially responsive to a comparison of the calculated string distance and a string distance threshold;
a timer to generate a value indicative of a time duration since a last indication generated by the comparator that corresponds to the calculated string distance exceeding the string distance threshold;
a corrector to output:
a transformed current randomly generated number at least partially responsive to detecting that the value generated by the timer exceeded a value of a time-out threshold; or
the current randomly generated number at least partially responsive to detecting that the value generated by a timer reset before exceeding the time-out threshold, and
a register to store the output of the corrector.

28. The system of claim 27, wherein the corrector generates an indication of the quality of the output stored at the register.
